(19) United States
(12) Patent Application Publication
(10) Pub. No.: US 2016/0026780 A1
(43) Pub. Date: Jan. 28, 2016

(54) SHADELESS TOUCH HAND-HELD ELECTRONIC DEVICE AND UNLOCKING METHOD THEREOF

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/748,736

(22) Filed: Jun. 24, 2015

(30) Foreign Application Priority Data
Jul. 25, 2014 (CN) 201410360304.9

(51) Int. Cl. G06F 21/32; G06F 3/01; G06F 3/0354; G06K 9/00

(52) U.S. Cl. CPC G06F 21/32; G06K 9/00013; G06K 9/00006; G06F 3/011; G06F 3/03547; G06F 3/03548; G06K 2009/00395; G06F 2203/04101; G06F 2203/04104; G06F 2200/1634; G06F 2200/1637

(57) ABSTRACT

An unlocking method of a shadeless touch hand-held electronic device comprising a panel, a touch-sensing cover, a control unit and a sensing unit comprises steps of: detecting a contact on a plurality of detection points of the touch-sensing cover when the hand-held electronic device is in a locked state of user interface; receiving a biometric data sensed by the sensing unit; comparing the biometric data with a predetermined biometric data stored in the hand-held electronic device; reading the contact to form a contact data; comparing the contact data with a predetermined contact data stored in the hand-held electronic device; and switching the hand-held electronic device into an unlocked state of user interface. A shadeless touch hand-held electronic device is also provided. This invention can enhance the secrecy and security during the unlocking operation, avoid the finger from shading the user' view and reduce the panel scratch problem.

### CROSS REFERENCE TO RELATED APPLICATIONS

This Non-provisional application claims priority under 35 U.S.C. §119(a) on Patent Application No(s). 201410360304.9 filed in People's Republic of China on Jul. 25, 2014, the entire contents of which are hereby incorporated by reference.

### BACKGROUND OF THE INVENTION

1. Field of Invention

This invention relates to a hand-held electronic device and an unlocking method thereof and, in particular, to a shadeless touch hand-held electronic device and an unlocking method thereof.

2. Related Art

With the progress of technologies, various novel information devices configured with communication function are invented, such as cell phones, tablet computers, ultrabooks, wearable devices and GPS (Global Positioning System) navigation devices. Generally, a keyboard and mouse are commonly used to manipulate a digital device for inputting information. Additionally, the touch control technology currently also becomes a popular manipulation method for a digital device and brings an intuitive operation. Accordingly, a touch display device adopting the touch control technology can provide a user friendly and intuitive interface for the input operation, and therefore users of all ages can manipulate the touch display device by fingers or a stylus. For the current hand-held electronic device configured with the touch function, the touch operation is almost executed directly on the panel.

In consideration of the information security, the biometric recognition can be applied to the unlocking function of an electronic device, wherein the fingerprint recognition is the most common technology applied thereto. However, when the operation or the biometric recognition is implemented on the panel, the user's fingers may shade the user's view or the functional item displayed by the panel, so that the user may erroneously touch an undesired item which is displayed in a high information density image by the finger. Besides, when the user inputs more secret information on the panel, such as implementing the unlocking operation by codes or another particular method, the people with bad intention may seize the chance to give a furtive glance and the information security is thus endangered.

Moreover, because the user needs to touch and operate the electronic device on the panel, the problem of panel scratch frequently happens. Furthermore, in the common use of the hand-held electronic device having the touch function, one hand is used to hold the electronic device while the other hand is used to execute the operation on the panel. So, when the user just uses one hand to hold and operate the device at the same time, the touch operation just can be limitedly executed by the thumb, and this is inconvenient for the operation. Besides, with the increased panel size of the hand-held electronic device, the single-hand multi-finger touch operation can't be achieved anymore.

Furthermore, the panel also needs to be configured with the rare earth transparent touch-sensing structure such as ITO (indium tin oxide) so as to be kept in touch and display functions, but the rare earth metal of indium is unceasingly consumed, the cost of the product is getting higher and higher. Besides, the conductivity of the rare earth metal is worse than the normal metal. Therefore, adopting the transparent touch-sensing layer made by the rare earth metal of indium is not a good choice. In addition, when the user uses the hand-held electronic device under the strong sunlight, the sunlight readability of the panel is always a problem that can't be effectively solved. Since the user can't see the information displayed on the panel, the operation is inconvenient as well.

Therefore, it is necessary to provide a shadeless touch hand-held electronic device and an unlocking method thereof whereby the secrecy of the unlocking operation can be enhanced, the user's view can be prevented from being shaded by the finger during the operation, the panel scratch problem can be reduced and the convenience of the single-hand operation can be enhanced.

### SUMMARY OF THE INVENTION

An aspect of the invention is to provide a shadeless touch hand-held electronic device and an unlocking method thereof whereby the secrecy and privacy of the unlocking operation can be enhanced, the user's view can be prevented from being shaded by the finger during the operation, the panel scratch problem can be reduced and the convenience of the single-hand operation can be enhanced.

Therefore, an unlocking method of a shadeless touch hand-held electronic device is disclosed in this invention. The shadeless touch hand-held electronic device comprises a panel, a touch-sensing cover, a control unit and a sensing unit. The unlocking method comprises steps of: detecting a contact on a plurality of detection points of the touch-sensing cover when the hand-held electronic device is in a locked state of user interface; receiving a biometric data sensed by the sensing unit; comparing the biometric data with a predetermined biometric data stored in the hand-held electronic device; reading the contact to form a contact data; comparing the contact data with a predetermined contact data stored in the hand-held electronic device; and switching the hand-held electronic device into an unlocked state of user interface.

In one embodiment, the contact comprises a slide, a click or a pressing.

In one embodiment, when the contact is a slide, the contact data is a sliding path and the predetermined contact data is a predetermined sliding path.

In one embodiment, after detecting the contact with the plurality of detection points, the unlocking method further comprises a step of: displaying an unlocking image on the panel.

In one embodiment, the contact comprises moving the unlocking image on the sliding path.

In one embodiment, the step of that the sensing unit receives the biometric data and the step of reading the contact are executed synchronously.

In one embodiment, when the contact is a click, the contact data comprises contact position and/or contact frequency, and the predetermined contact data comprises predetermined contact position and/or predetermined contact frequency.

In one embodiment, the biometric data comprises fingerprint, iris, gesture or palmprint.

In one embodiment, the sensing unit comprises a fingerprint recognition unit, an iris recognition unit, a gesture recognition unit or a palmprint recognition unit.

In one embodiment, the predetermined biometric data comprises a fingerprint pattern, an iris pattern, a gesture pattern or palmprint pattern.

In one embodiment, the user operates the hand-held electronic device by one hand.

Moreover, a shadeless touch hand-held electronic device of this invention comprises a panel, a touch-sensing cover, a sensing unit and a control unit. The touch-sensing cover comprises a cover and a touch-sensing structure. Partial or total area of the touch-sensing structure is disposed on the cover and the touch-sensing structure comprises a plurality of detection points. The control unit is electrically connected with the panel, the touch-sensing cover and the sensing unit and executes the steps of: detecting a trigger event from a plurality of detection points of the touch-sensing cover when the hand-held electronic device is in a locked state of user interface; receiving a biometric data sensed by the sensing unit; comparing the biometric data with a predetermined biometric data stored in the hand-held electronic device; reading a contact between the user and the plurality of detection points of the touch-sensing cover to form a contact data; comparing the contact data with a predetermined contact data stored in the hand-held electronic device; and switching the hand-held electronic device into an unlocked state of user interface.

In one embodiment, the hand-held electronic device is applied to single-hand multi-touch operation.

In one embodiment, a circuit board, a battery or a memory card is disposed between the touch-sensing cover and the panel.

In one embodiment, the sensing unit comprises a fingerprint recognition unit, an iris recognition unit, a gesture recognition unit or a palmprint recognition unit.

In one embodiment, the sensing unit is coupled with the touch-sensing cover.

In one embodiment, a wiring connecting to the touch-sensing structure is gathered to a single side for wiring outlet.

In one embodiment, the width of the touch-sensing structure is slightly less than that of the cover by 5%˜10%.

In one embodiment, the area of the touch-sensing structure and the area of the panel have a ratio relationship, and the control unit converts an input position into a display position of the panel according to the ratio relationship.

In one embodiment, the touch-sensing structure comprises metal mesh, metal nanowires, transparent conducting layer, carbon nanotube or graphene.

In one embodiment, the hand-held electronic device is operated by one hand.

In one embodiment, the touch-sensing cover further comprises a near field communication unit, which comprises a near field communication chip and an antenna, the near field communication chip is electrically connected with the control unit, and the antenna is disposed on the cover or the touch-sensing structure.

As mentioned above, in the shadeless touch hand-held electronic device and unlocking method thereof according to this invention, the user can execute the touch operation on the touch-sensing cover of the shadeless touch hand-held electronic device, so the finger of the user won't only shade the user's view or the software object displayed on the panel, but also the touch for opening the link in the high information density image won't be erroneously executed. Besides, since the user operates the electronic device via the touch-sensing cover, the panel scratch problem can be reduced. Moreover, because the user can execute the touch operation on the touch-sensing cover, the user can easily execute the unlocking operation through the biometric recognition while the panel won't be shaded just by using one hand holding the hand-held electronic device. In comparison with the conventional art where the user just can use the thumb to execute the operation while using the same hand holding the device, this invention can provide more efficiency and convenience for the manual operation and a wonderful user experience can be achieved.

Furthermore, on the premise that the biometric data (ex. palmprint) inputted by the user corresponds to the initiative determination condition (ex. the predetermined biometric data inputted by the user in advance) and the contact data inputted by the user corresponds to the predetermined contact data, the touch-sensing cover just can be permitted to receive at least one input action inputted by the user for executing and the panel correspondingly could be operative. Therefore, when other users want to operate the hand-held electronic device, the operation will be forbidden because the biometric data or the contact data doesn't corresponds to the preset predetermined biometric data or predetermined contact data. Thereby, the security and secrecy of the hand-held electronic device can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a shadeless touch hand-held electronic device of an embodiment of the invention;

FIG. 2 is a function block diagram of the hand-held electronic device shown in FIG. 1;

FIG. 3 is a schematic diagram of the hand-held electronic device of FIG. 1 in another viewing angle;

FIG. 4 is a schematic flowchart of the unlocking method of the shadeless touch hand-held electronic device of an embodiment of the invention;

FIG. 5 is a schematic diagram showing one operation state of the hand-held electronic device of FIG. 1;

FIG. 6 is a schematic diagram showing another operation state of the hand-held electronic device of FIG. 1;

FIGS. 7A to 7C are schematic diagrams showing the detection point of the touch-sensing cover of FIG. 1 is triggered;

FIGS. 8A to 8D are schematic diagrams of the operations implemented according to the step S40 of the unlocking method of FIG. 4;

FIG. 9 is a schematic diagram of another operation implemented according to the step S40 of the unlocking method of FIG. 4; and

FIG. 10 is a schematic diagram of the unlocking method of another embodiment of the invention.

### DETAILED DESCRIPTION OF THE INVENTION

The present invention will be apparent from the following detailed description, which proceeds with reference to the accompanying drawings, wherein the same references relate to the same elements.

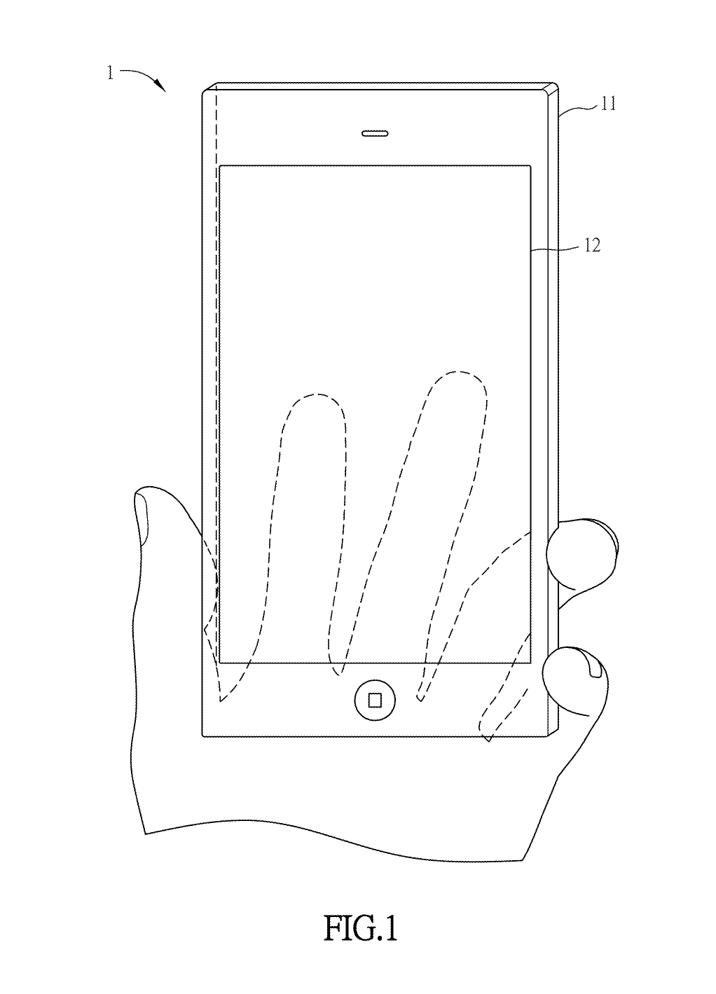

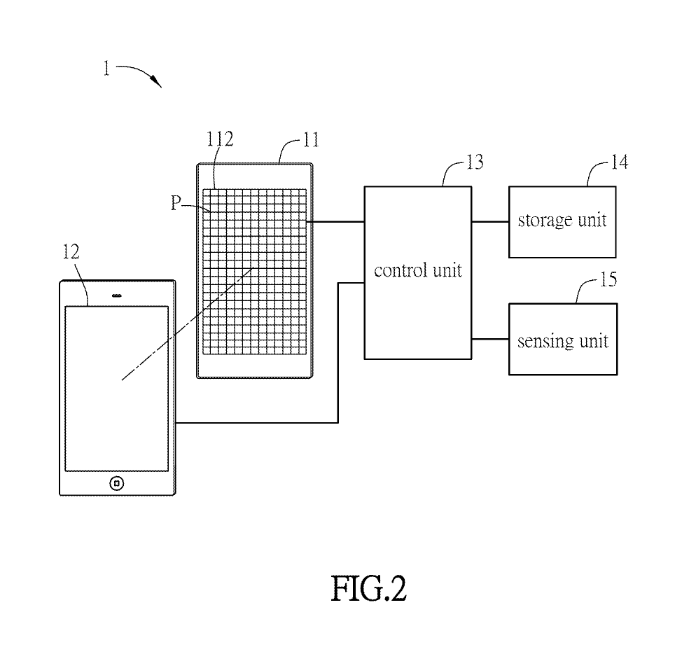

FIG. 1 is a schematic diagram of a shadeless touch hand-held electronic device of an embodiment of the invention, and FIG. 2 is a function block diagram of the hand-held electronic device shown in FIG. 1. As shown in FIGS. 1 and 2, the shadeless touch hand-held electronic device 1 (hereinafter abbreviated as hand-held electronic device 1) of this embodiment includes a touch-sensing cover 11, a panel 12 and a control unit 13. The panel 12 can include a display panel, i.e. a panel with the display function, or a touch display panel having both functions of display and touch. The hand-held electronic device 1 of this embodiment can comprise a smart phone, a tablet, a personal digital assistant (PDA) or a global positioning system (GPS) device, and this embodiment gives the illustration by taking the smart phone as an example.

In this embodiment, the touch-sensing cover 11 is disposed on the side of the hand-held electronic device 1 against the panel 12. In other words, the touch-sensing cover 11 and the panel 12 are disposed on the opposite sides of the hand-held electronic device 1, i.e. the rear side and the front side of the hand-held electronic device 1, respectively. In this embodiment for example, the panel 12 is disposed on the front side of the hand-held electronic device 1, and the touch-sensing cover 11 is disposed on the rear side of the hand-held electronic device 1. In practical, a circuit board, a battery or a memory card can be disposed between the touch-sensing cover 11 and the panel 12 to act as the component parts in the hand-held electronic device 1. However, this invention is not limited thereto, and the component can be added or removed according to the practical requirement or actual design. The touch-sensing cover 11 and the panel 12 are coupled with the control unit 13 so that the control unit 13 can control the content displayed on the panel 12 and control a specific region of the touch-sensing cover 11 can be touched for user's input.

In physical, the touch-sensing cover 11 of this embodiment provides an input interface which is used as a human-machine interface. For example, the panel 12 can display a user interface, such as a graphical user interface (GUI). Therefore, as shown in FIG. 1, the user can see the content displayed by the panel 12 through the front side of the hand-held electronic device 1 and execute the input operation through the touch-sensing cover 11 on the rear side. When the user uses the hand-held electronic device 1 under the sunlight or a light source, the user can operate the hand-held electronic device 1 by one hand and also adopt the touch-sensing cover 11 to face the light source to block the sunlight or the light source. Because the panel 12 is against the light source, the touch-sensing cover 11 can block the sunlight or the light source and the sunlight readability of the panel 12 can be thus enhanced. Besides, the user can just use one hand to execute the operation or input for the content displayed on the panel through the touch-sensing cover, so as to enhance the operation security of the hand-held electronic device and improve the convenience of the single-hand operation under the sunlight.

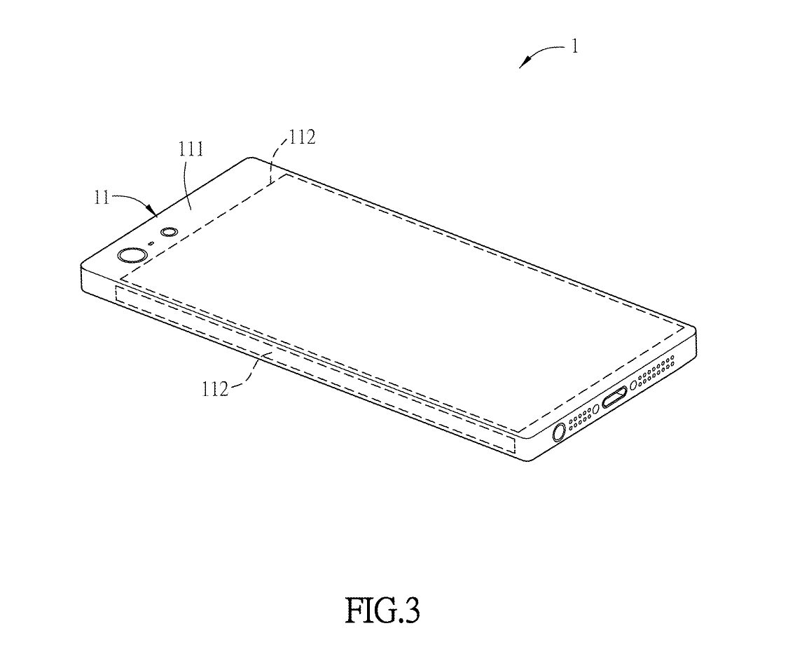

FIG. 3 is a schematic diagram of the hand-held electronic device of FIG. 1 in another viewing angle. As shown in FIGS. 2 and 3, in this embodiment, the touch-sensing cover 11 includes a cover 111 and a touch-sensing structure 112. Likewise, the cover 111 is disposed on the side of the hand-held electronic device 1 opposite the panel 12 (the opposite side of the display surface). Partial or total area of the touch-sensing structure 112 can be disposed on the cover 111. For example, the touch-sensing structure 112 may also yield to the position of the camera lens or flash of the cover 111, so the touch-sensing structure 112 is not disposed at a local region of the cover 111 (namely the location where the camera lens or the flash are disposed). The local region refers to the inside of the cover 111 or the edge of the cover 111.

In this embodiment, the touch-sensing structure 112 is extended to the two sides of the cover 111 and to the two sides of the touch-sensing cover 11 in order to increase the operation area for the user. For more effectively using the width of the cover 111 to dispose the touch-sensing structure 112, the width of the touch-sensing structure 112 can be slightly less than that of the cover 111 (such as by 5%˜10%). That is, the width of the touch-sensing structure 112 is about 90%˜95% that of the cover 111. In other embodiments, the physical key can be replaced by the touch-sensing structure 112 of this embodiment.

The wiring connecting to the touch-sensing structure 112 can be gathered to a single side for the wiring outlet and then electrically connected with a circuit board, so as to enhance the flexibility of the circuit design.

In other embodiments, the area of the touch-sensing structure of the touch-sensing cover can be less than that of the panel. In other words, the area of the touch-sensing structure and the area of the panel have a ratio relationship. The control unit will convert an input position into a display position of the panel according to the ratio relationship.

The touch-sensing structure 112 can be disposed on the inner surface of the cover 111 (the inside of the hand-held electronic device 1) facing the panel 12, or on the outer surface of the cover 111 opposite the panel 12 (the outside of the hand-held electronic device 1), or on the inner surface of the cover 111 facing the panel 12 and the outer surface of the cover 111 opposite the panel 12 (the inside and the outside of the hand-held electronic device 1). The touch-sensing structure 112 of this embodiment can be a capacitive touch-sensing structure for example and formed on the inner surface of the cover 111 facing the panel 12, and is directly formed on the cover 111 with the total area for example. In different embodiments, if the touch-sensing structure 12 is disposed on the outer surface of the cover 111 which is farther from the panel 12, a protection layer is required for protecting the touch-sensing structure 112. To be noted, the material of the cover 111 can be glass, plastic material, metal or other materials, and the cover 111 is a part of the whole structure of the hand-held electronic device 1. In other words, the touch-sensing cover 11 is not an additional component (the additional component is the protection cover of the electronic device for example), so if the touch-sensing cover 11 is separated from the hand-held electronic device 1, the inside components of the hand-held electronic device 1, such as battery or integrated circuit, can be seen. The touch-sensing structure 112 can further include a driving circuit and a sensing circuit (i.e. the so-called Tx and Rx, not shown), and the material thereof can comprise conducting layer (such as a transparent conducting layer, including indium tin oxide (ITO), indium zinc oxide (IZO), fluorine-doped tin oxide (FTO), Al-doped ZnO, Ga-doped ZnO for example), metal nanowires, graphene, metal mesh or carbon nanotube, but this invention is not limited thereto.

If the touch-sensing structure 112 is made by metal mesh, the metal texture effect can be exhibited on the appearance when the touch-sensing structure 112 is disposed on the outer surface (not the display surface) of the cover 111. Accordingly, because the metal texture effect can be achieved just by disposing the touch-sensing structure 112 composed of the metal mesh on the outer surface (not the display surface) of the cover 111 made by non-metal material, the metal-made cover (requiring a more complicated process) is not necessary to be adopted and cost down can be achieved.

As shown in FIG. 2, the touch-sensing structure 112 comprises a plurality of detection points P, which can be triggered to sense a trigger event. For example, when a user touches (such as adopting a stylus, finger or palm) the touch-sensing structure 112, the detection point P at the touch position can be triggered to generate the signal of the trigger event, and the signal will be transmitted to the control unit 13 for the judgment or analysis of the control unit 13 to the trigger event. Accordingly, the trigger event can be generated by corresponding to the holding position of the user when the user holds the touch-sensing cover 11, or can be generated when the user executes the input operation through the touch-sensing cover 11.

That the user executes the input operation on the touch-sensing cover 11 indicates that the user can operate the hand-held electronic device 1 on the touch-sensing cover 11, as shown in FIG. 1. Besides, the panel 12 can display the corresponding operation according to the user's operation gesture (or called the hand gesture), and the user can operate the user interface displayed on the panel 12. For example, when the user's finger slides on the touch-sensing cover 11, the panel 12 will display a corresponding image (such as an arrow or hand shape) which slides correspondingly.

Accordingly, the touch-sensing cover 11 and the panel 12 are respectively disposed on the opposite sides of the hand-held electronic device 1, so as to prevent the image of the panel 12 from being shaded by the user's finger while the user operates the hand-held electronic device 1 and also avoid the erroneous touch situation.

As shown in FIG. 2, the hand-held electronic device 1 of this embodiment further comprises a storage unit 14, which is, for example but not limited to, ROM (read-only memory), RAM (random access memory), flash, field-programmable gate array (FPGA) or other kinds of memories. Herein for example, the storage unit 14 is illustrated as the RAM and coupled with the control unit 13 by a signal bus.

In this embodiment, the storage unit 14 stores the operation system, application programs, data processing programs and electronic data of various formats. The operation system is the program managing the computer hardware and software resources. The application program can be a word processing program, email program or others. The data processing program can be used to detect the data structure of the above-mentioned electronic data and generate the corresponding connection instruction. In this embodiment, the control unit 13 comprises a central processing unit (CPU) for example to execute the programs.

In some embodiments, the hand-held electronic device can further comprise a near field communication unit, which comprises a near field communication chip and an antenna. The near field communication chip is electrically connected with the control unit, and the antenna can be disposed on the cover or the touch-sensing structure for example, but this invention is not limited thereto. When the user wants to use the hand-held electronic device to communicate with another electronic device through the near field communication (NFC), the hand-held electronic device 1 can be made closer to another electronic device having the near field communication function to receive data from or transmit data to the other electronic device through the antenna and the near field communication chip.

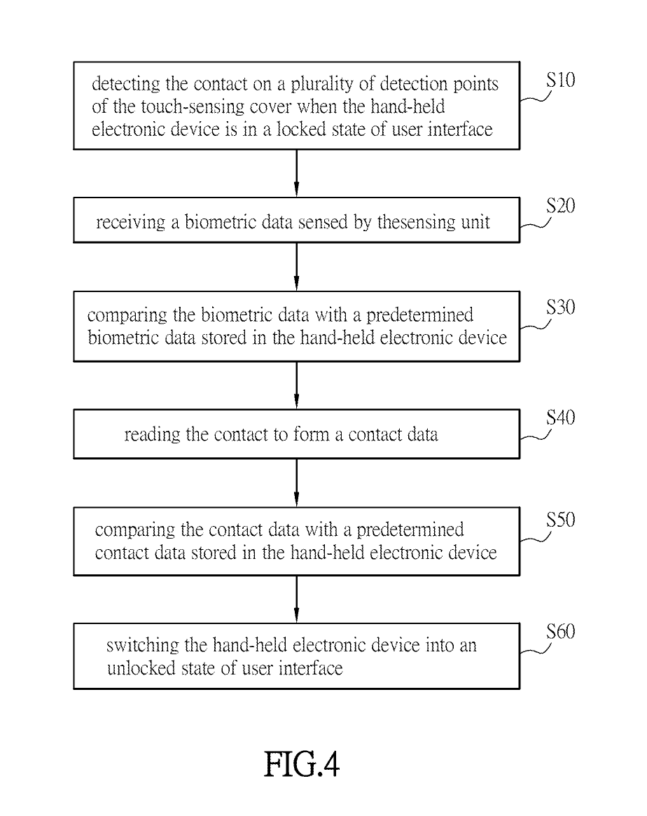

FIG. 4 is a schematic flowchart of the unlocking method of the shadeless touch hand-held electronic device of an embodiment of the invention. As shown in FIG. 4, the unlocking method of the shadeless touch hand-held electronic device of this embodiment (abbreviated as the unlocking method) is adopted to determine the input action corresponding to the user's hand gesture for unlocking the hand-held electronic device 1. The unlocking method includes the following steps of: detecting the contact on a plurality of detection points of the touch-sensing cover when the hand-held electronic device is in a locked state of user interface (step S10); receiving a biometric data sensed by the sensing unit (step S20); comparing the biometric data with a predetermined biometric data stored in the hand-held electronic device (step S30); reading the contact to form a contact data (step S40); comparing the contact data with a predetermined contact data stored in the hand-held electronic device (step S50); and switching the hand-held electronic device into an unlocked state of user interface (step S60).

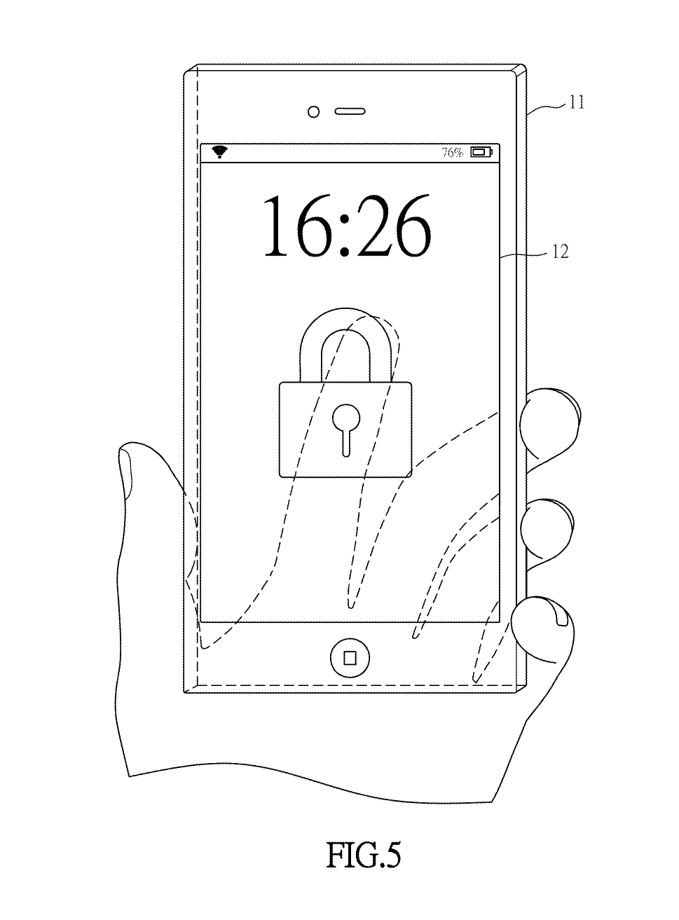

As shown in FIGS. 1, 2, 4 and 5, FIG. 5 is a schematic diagram showing the hand-held electronic device of FIG. 1 is in the locked state of user interface. Physically, in the step S10, when the hand-held electronic device 1 is in the locked state of user interface (as shown in FIG. 5), the contact between the user and the touch-sensing cover is detected. Herein, the so-called locked state of user interface (called the locked state hereinafter) refers to that the hand-held electronic device 1 still can be charged and operated but the most user's input are disabled. In other words, the hand-held electronic device 1 will not execute any action in response to the user's input. In the locked state, the hand-held electronic device 1 still can respond to some kind of the contact on the touch-sensing cover 11. The so-called some kind of the contact comprises the contact that is defined by the hand-held electronic device 1 as the contact that is related to make the hand-held electronic device 1 switched into the unlocked state of user interface, for example, when the user touches the panel 12 by a finger, presses the physical key of the hand-held electronic device 1 or shakes the hand-held electronic device 1. However, this invention is not limited thereto.

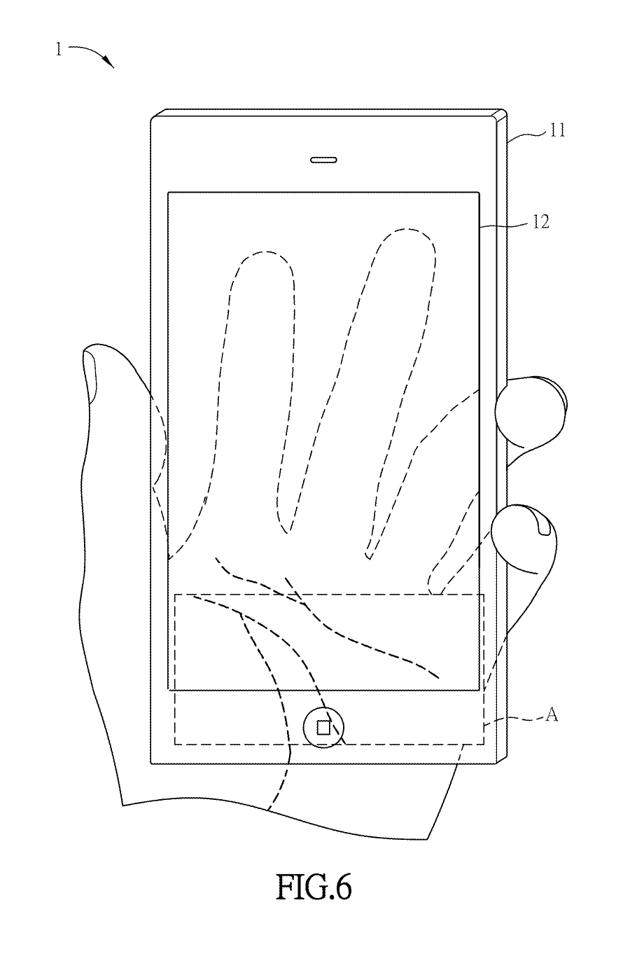

When the control unit 13 detects the contact in the step S10, the step S20 will be executed. As shown in FIGS. 1, 2, 4 and 6, FIG. 6 is a schematic diagram of the operation of the hand-held electronic device 1 of FIG. 1 in another state. In the step S20, a biometric data sensed by the sensing unit 15 is received. In this embodiment, the hand-held electronic device 1 further comprises a sensing unit 15, which is a palmprint recognition unit in this embodiment for example. The location of the palmprint recognition unit is not limited to this embodiment, and can be disposed in the area A in FIG. 6 to correspond to the position of the contact between the user's palm and the touch-sensing cover 11. The palmprint recognition unit is electrically connected with the control unit 12 and can recognize at least a part of the user's palmprint. In practical, the user can pre-store the palmprint pattern in the storage unit 14. In the step S20, the user can put the palm on the specific area A of the cover 111 of the touch-sensing cover 11. Then, in the step S30, the control unit 13 compares the biometric data with a predetermined biometric data stored in the hand-held electronic device. In this embodiment, the control unit 13 can compare the palmprint in the specific area with the pre-stored palmprint. If the biometric data (palmprint) corresponds to the predetermined biometric data (palmprint pattern), the user is permitted to execute the subsequent operation. If they don't correspond to each other, the control unit 13 determines the user is not a permitted user and the subsequent operation can't be executed, and the hand-held electronic device 1 is kept in the locked state.

To be noted, in practical, the sensing unit 15 also can be designed as a fingerprint recognition unit, gesture recognition unit or an iris recognition unit, and the biometric data sensed by the sensing unit 15 can be a fingerprint, a gesture or an iris correspondingly. However, this invention is not limited thereto.

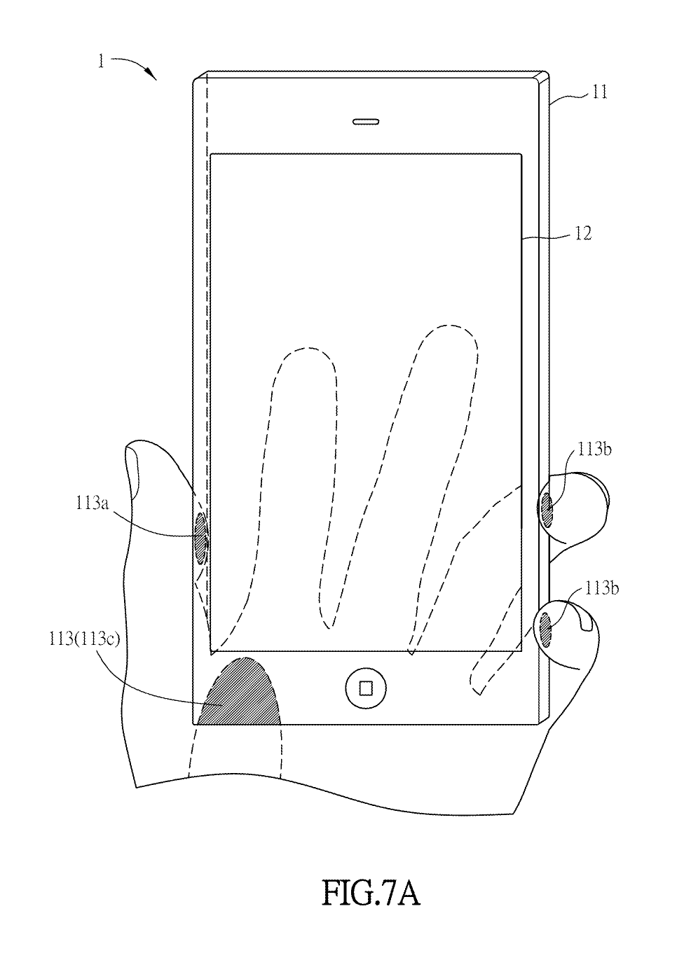

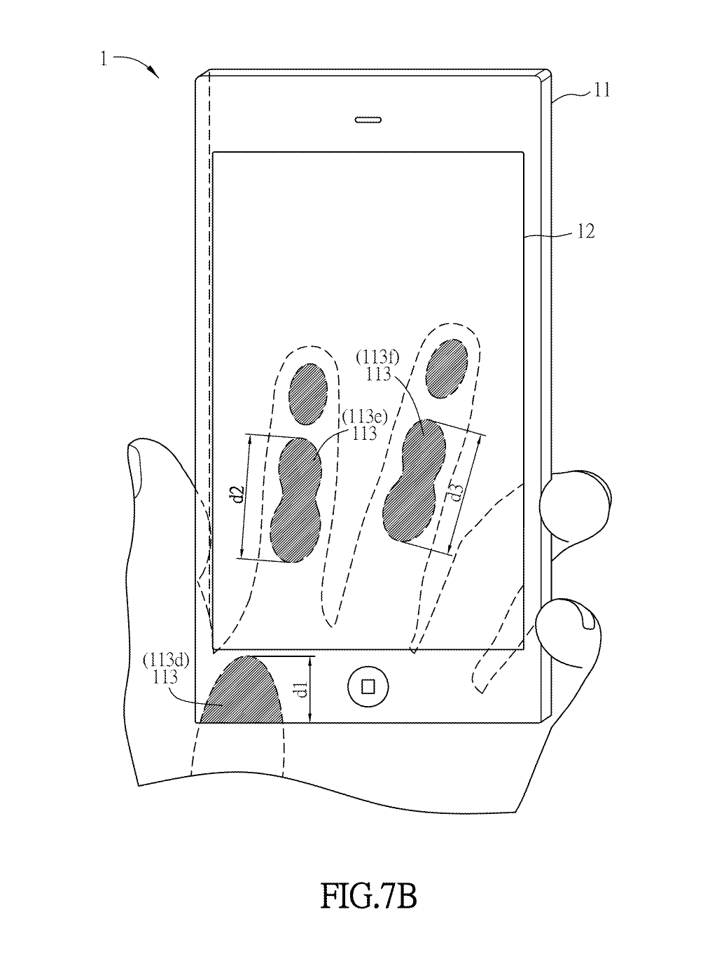

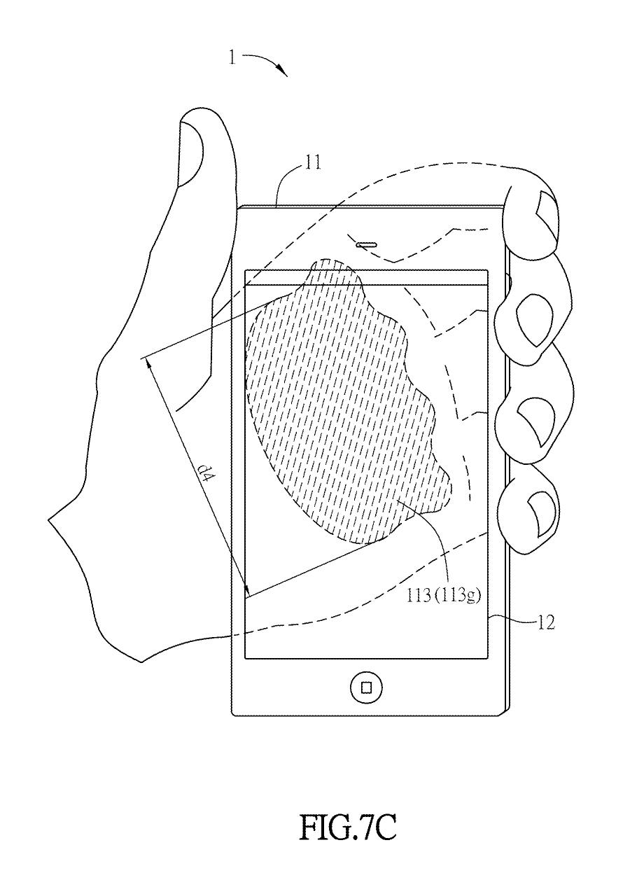

In other embodiments, the biometric data may be the holding feature of the user holding the hand-held electronic device. FIGS. 7A to 7C are schematic diagrams showing the detection point of the touch-sensing cover of FIG. 1 is triggered. As shown in FIG. 7A, when the user operates the hand-held electronic device 1, the user can preset the holding usage or posture when operating the setting interface, accordingly, the control unit 13 can analyze the trigger event of the detection point triggered by the user when operating the setting interface. The trigger event can be defined as the initiative determination condition and stored in the storage unit 14. The trigger event comprises the trigger quantity, trigger quantity distribution, trigger time, trigger frequency, trigger morphology (which can refer to trigger appearance) or trigger location (which can refer to trigger position). As to the trigger event of the trigger quantity distribution, trigger morphology or trigger location for example, when the user holds the hand-held electronic device 1, the control unit 13 can analyze the detection point which is triggered by the user's holding and define the region where the number of the adjacent triggered detection points P is larger than a predetermined range as a trigger area 113. As shown in FIG. 7A, in this embodiment, one of the sidewalls of the touch-sensing cover 11 has a trigger area 113a, the other sidewall has two trigger areas 113b, and the surface of the touch-sensing cover 11 opposite the panel 12 has a trigger area 113c. Furthermore, in this embodiment, the trigger quantity distribution and the trigger location respectively indicate the quantity and the location of each trigger area and the trigger morphology indicates the shape or appearance of each trigger area 113, i.e. the shapes or appearance of the trigger areas 113a, 113b and 113c. Moreover, the trigger frequency can indicate the click frequency at a certain location or specific position, and the trigger time indicates that the holding time exceeds a certain time or related to the user's personal habit.

Accordingly, after the user completes the setting through the setting interface and the storage unit 14 stores the initiative determination condition, the control unit 13 can compare other trigger events with the initiative determination condition. If other trigger events occur, the control unit 13 will compute the trigger quantity, trigger quantity distribution, trigger time, trigger frequency, trigger morphology or trigger location of the detection point on the touch-sensing cover 11 triggered by other trigger events, and also compare the computed result with the initiative determination condition pre-stored in the hand-held electronic device 1. In other embodiments, in order to enhance the security and secrecy of the hand-held electronic device 1, the control unit 13 will compute the trigger event on the touch-sensing cover 11 at the predetermined time intervals. In other words, the control unit 13 will compute the trigger quantity, trigger quantity distribution, trigger time, trigger frequency, trigger morphology or trigger location of the detection point triggered at different times.

In this embodiment, when the setting is completed and a conductor (such as the user's finger) touches the touch-sensing cover 11, accordingly, the control unit 13 can compute the trigger event (the biometric data) of the triggered detection point P and compare the biometric data obtained by the computation with the predetermined biometric data pre-stored in the hand-held electronic device, after receiving the touch signal.

Furthermore, when the biometric data in the step S30 corresponds to the predetermined biometric data, the step S40 is executed to read a contact between the user and a plurality of detection points P of the touch-sensing cover 11 to form a contact data. The so-called contact can comprise a slide, a click or a pressing. The slide can refer to that the user's finger contacts the touch-sensing cover 11, moves the contact point to another area while keeping the contact and then terminates the contact in the area for example. The click can refer to that the user discontinuously touches the touch-sensing cover 11 within a predetermined duration for example. The pressing can refer to that the user touches the touch-sensing cover 11 within a predetermined force level for example. The contact is a slide in this embodiment for example, and the click manner will be illustrated in the following embodiment.

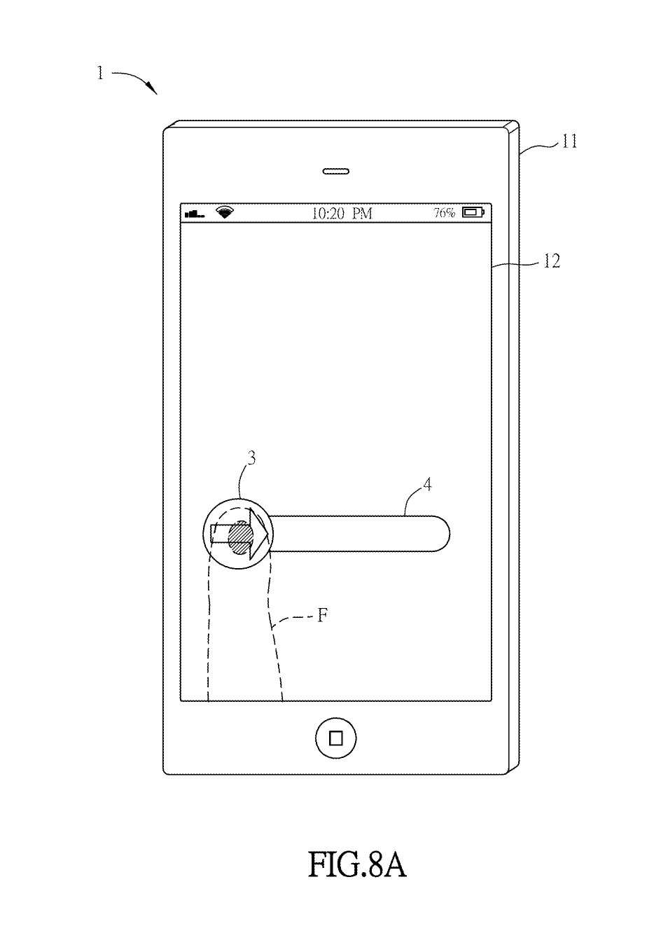

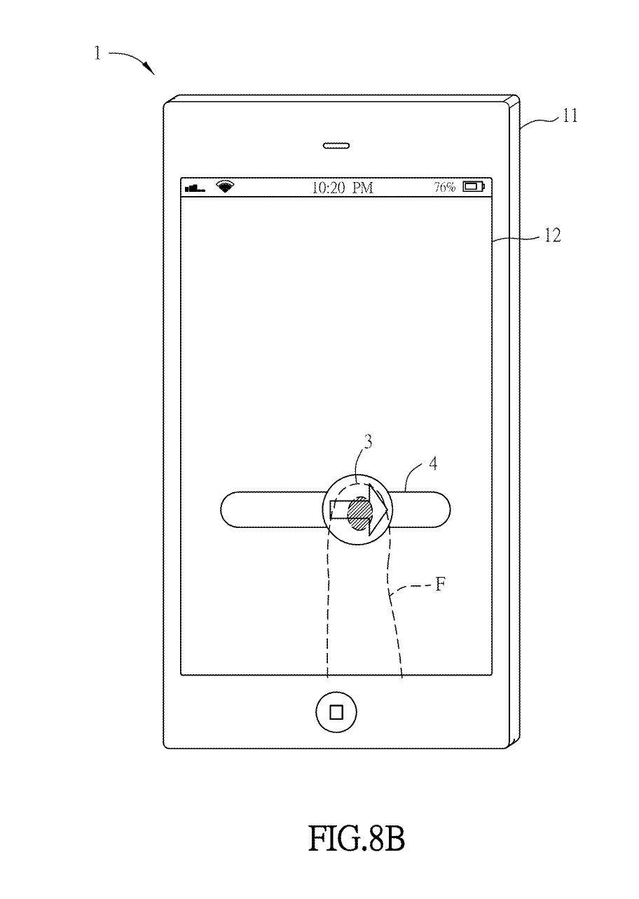

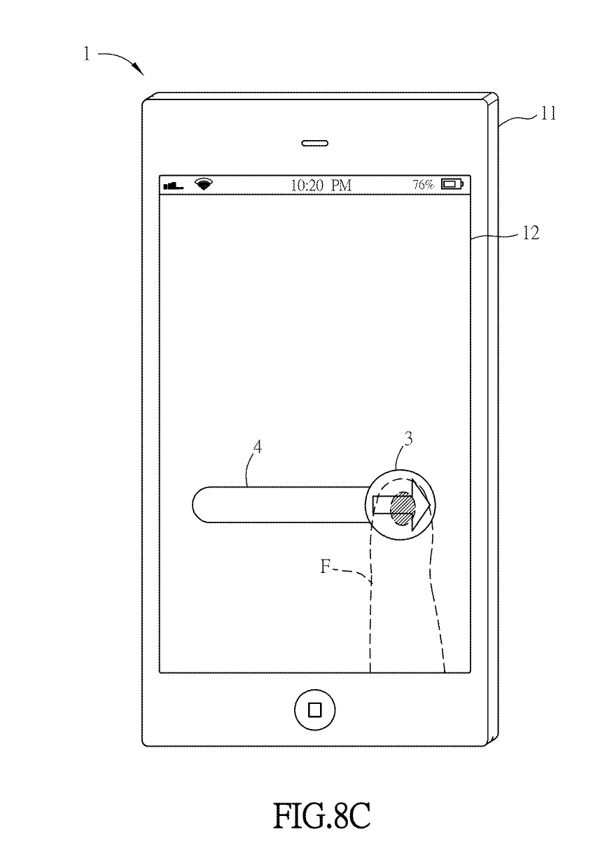

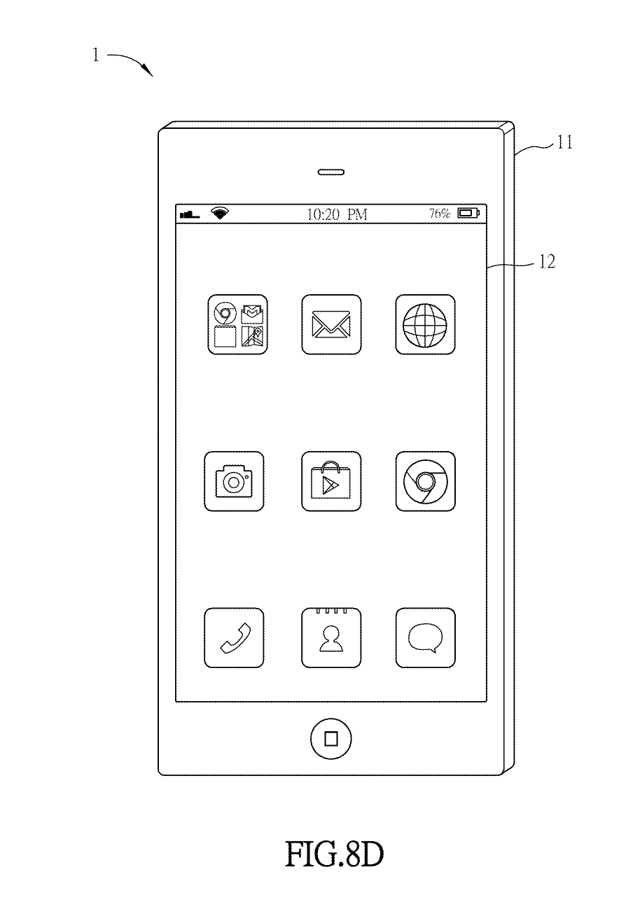

The following is the illustration given by taking the contact in the step S40 as a slide. FIGS. 8A to 8D are schematic diagrams of the operations implemented according to the step S40 of the unlocking method of FIG. 4. As shown in FIGS. 4, 8A to 8D, in this embodiment, the user touches the touch-sensing cover 11 by the finger F to start to execute the unlocking action. The panel 12 will display an unlocking image 3 when the contact happens. At this time, the user can put the finger on the position corresponding to the unlocking image 3 to touch the touch-sensing cover 11. The unlocking image 3 of this embodiment is at the left end of the channel 4 in the beginning. The contact overlapping the unlocking image 3 or near the unlocking image 3 can be detected by the control unit 13, and the control unit 13 can execute the process according to the event that the user's finger F is correspondingly touching the unlocking image 3.

In FIG. 8B, the user can move the finger according to the moving direction (from left to right in this embodiment) indicated by the unlocking image, wherein the user's finger F continuously contacts the touch-sensing cover 11. At this time, the unlocking image 3 will be drawn along the channel 4. The disposition of the channel 4 is used to indicate the direction along with the user's finger moving (this embodiment gives the horizontal move for example)

In FIG. 8C, the user has drawn the unlocking image 3 to the right end of the channel 4. Once the user releases the unlocking image 3 at the right end of the channel 4, the step S40 is completed. While the step S40 is executed, the step S50 is also executed for giving the comparison. In detail, while the user's finger slides on the touch-sensing cover 11, the control unit 13 compares the contact data with a predetermined contact data pre-stored in the hand-held electronic device. Then, if the contact data corresponds to the predetermined contact data, the hand-held electronic device 1 is switched to the unlocked state of user interface (step S60). Therefore, if the user who doesn't know the predetermined contact data tries to operate the hand-held electronic device 1, the hand-held electronic device 1 can't be unlocked because the contact data doesn't correspond to the predetermined contact data that is preset by the user, so as to enhance the security and safety of the whole hand-held electronic device 1. Since the unlocking method of this embodiment is implemented on the touch-sensing cover 11, the contact data that is formed by the sliding path of the finger is uneasy to be furtively glanced by those with bad intention when the owner of the hand-held electronic device 1 or the trusted user executes the touch operation, and thereby the secrecy can be enhanced.

In this embodiment, the step S60 is illustrated by FIG. 8D. Once the comparison between the contact data and the predetermined contact data is completed, in other words, the hand-held electronic device 1 is switched to the unlocked state, the panel 12 of the hand-held electronic device 1 can display at least one user interface icon corresponding to at least one function and/or the information that the user may be interested in. The user interface icons are the images forming the user interface of the device, and comprise characters, figures, marks, virtual keys, drop-down menu, list button, confirmation box, list, etc. However, this invention is not limited thereto. The user interface icons can comprise non-interactive objects for transmitting information or constituting the appearance of the user interface, interactive objects for the user's operation or their combination.

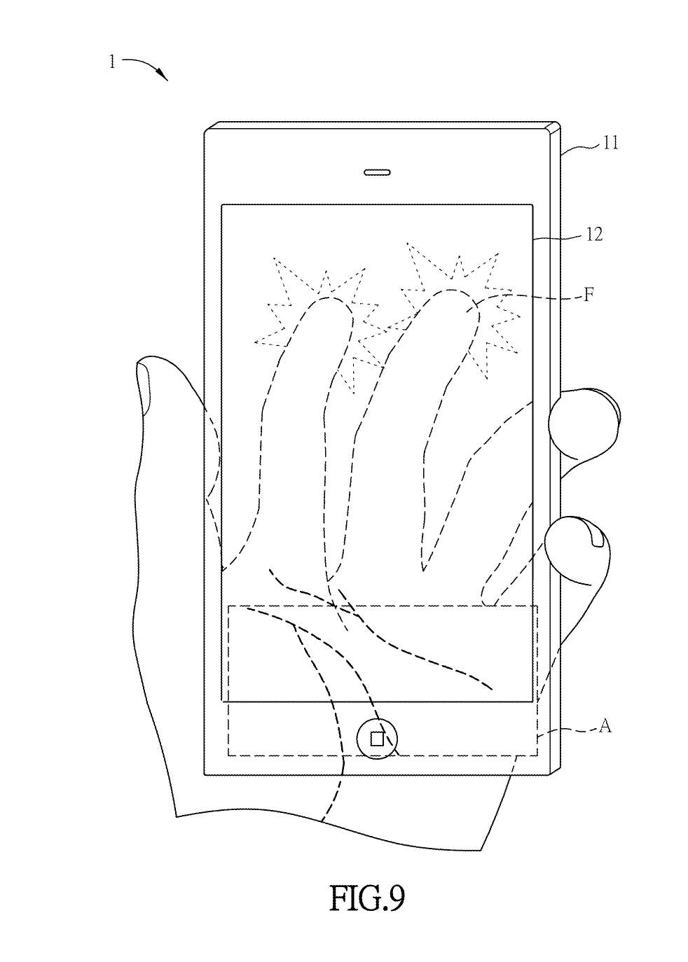

As shown in FIGS. 4 and 9, in other embodiments, the contact between the user's finger F and the touch-sensing cover 11 in the step S40 also may be implemented in a click manner. In other words, the user can click on the touch-sensing cover 11 by the finger F. At this time, the formed contact data comprises contact (click) position and/or contact (click) frequency, and the predetermined contact data stored in the hand-held electronic device 1 comprises predetermined contact position and/or predetermined contact frequency. The user can continuously or discontinuously touch the touch-sensing cover 11 in a single-point or multi-point manner to achieve the purpose of unlocking. As to the unlocking method implemented in a click manner, the click position or click frequency is not limited to the embodiments of this invention and can be determined according to the user's setting or the manufacturer's design.

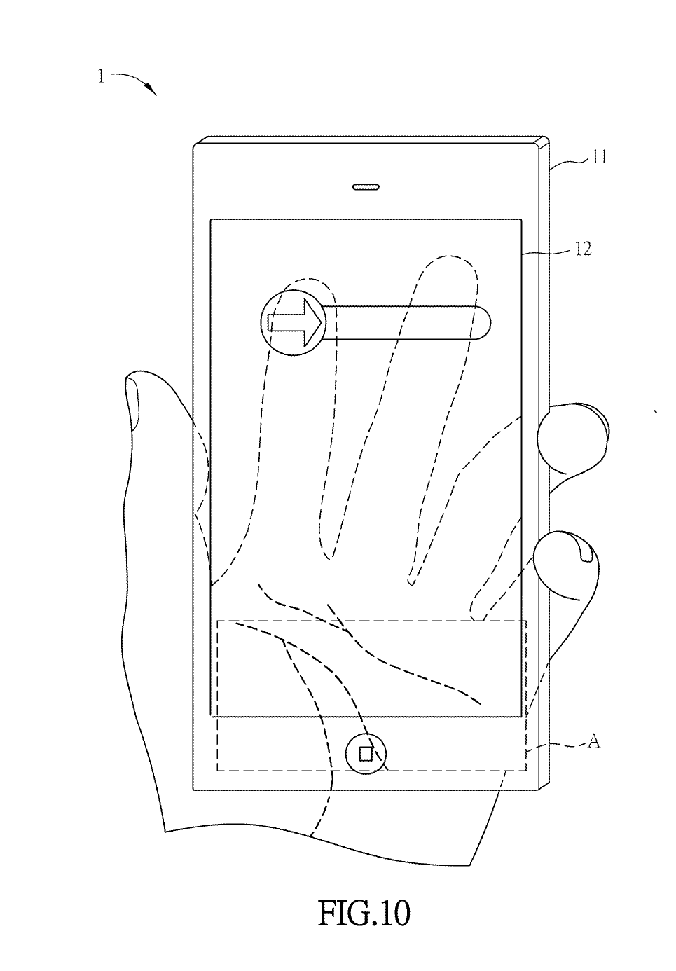

As to the unlocking method of double mechanisms, the execution manner thereof is not limited to the method of the above illustrations. FIG. 10 is a schematic diagram of the unlocking method of another embodiment of the invention. As shown in FIGS. 4 and 10, the steps S20 and S40 can be executed synchronously. In other words, the step of that the sensing unit 15 receives a biometric data and the step of reading the contact are executed synchronously. In this embodiment for example, in order to permit that the steps S20 and S40 can be executed synchronously, the sensing unit 15 can be disposed in the area A, and the contact area in the step S40 for the sensing can be located on the upper portion of the hand-held electronic device 1. Herein, the upper portion can be defined according to the central line of the cover or the central line of the touch-sensing structure and under the situation of the user operating the hand-held electronic device 1. The portion above the central line is the upper portion.

By executing the sensing of the biometric data and the contact recognition synchronously, the time required for unlocking the hand-held electronic device 1 can be saved so as to enhance the operability of the hand-held electronic device 1.

In addition, because the unlocking method provided by the embodiment is executed on the touch-sensing cover 11 of the hand-held electronic device 1, the user's finger will neither shade the view or the software object displayed on the panel, nor the touch for opening the link in the high information density image will be erroneously executed. Since the user can execute the touch operation on the touch-sensing cover 11, the user just needs to hold the hand-held electronic device 1 by one hand to easily execute the unlocking operation through the biometric recognition while the panel 12 won't be shaded. In comparison with the conventional art where the user just can limitedly use the thumb to execute the operation while using the same hand holding the device, this invention can provide more efficiency and convenience for the manual operation.

Because the unlocking method and the hand-held electronic device disclosed in the embodiment can be applied to multi-point touch operation by single hand, which is different from the conventional operation manner of the hand-held electronic device, the convenience of the user's single-hand operation can be further enhanced. For example, the user needs to send a notice of the front landslide road condition during the emergent drive.

Summarily, referred to the shadeless touch hand-held electronic device and unlocking method thereof according to this invention, the user can execute the input operation on the touch-sensing cover of the shadeless touch hand-held electronic device, so the user's finger won't shade the user's view or the software object displayed on the panel, hence, the touch for opening the link in the high information density image won't be erroneously executed. Besides, since the user operates the electronic device through the touch-sensing cover, the panel scratch problem can be reduced. Moreover, since the user can execute the touch operation on the touch-sensing cover, the user can easily execute the unlocking operation through the biometric recognition while the panel won't be shaded just by using one hand holding the hand-held electronic device. In comparison with the conventional art where the user just can limitedly adopt the thumb to execute the operation while using the same hand holding the device, this invention can provide more efficiency and convenience for the manual operation and a wonderful user experience can be achieved.

Furthermore, on the premise that the biometric data (ex. palmprint) inputted by the user corresponds to the initiative determination condition (ex. The predetermined biometric data inputted by the user in advance) and the contact data inputted by the user corresponds to the predetermined contact data, the touch-sensing cover just can be permitted to receive at least one input action inputted by the user for executing and the panel correspondingly could be operative. Therefore, when other users want to operate the hand-held electronic device, the operation will be forbidden because the biometric data or the contact data doesn't corresponds to the preset predetermined biometric data or predetermined contact data. Thereby, the security and safety of the hand-held electronic device can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An unlocking method of a shadeless touch hand-held electronic device comprising a panel, a touch-sensing cover, a control unit and a sensing unit, comprising steps of:
detecting a trigger event from a plurality of detection points of the touch-sensing cover when the hand-held electronic device is in a locked state of user interface;
receiving a biometric data sensed by the sensing unit;
comparing the biometric data with a predetermined biometric data stored in the hand-held electronic device;
reading a contact between the user and the plurality of detection points of the touch-sensing cover to form a contact data;
comparing the contact data with a predetermined contact data stored in the hand-held electronic device; and
switching the hand-held electronic device into an unlocked state of user interface.

2. The unlocking method as recited in claim 1, wherein the contact comprises a slide, a click or a pressing.

3. The unlocking method as recited in claim 2, wherein when the contact is a slide, the contact data is a sliding path and the predetermined contact data is a predetermined sliding path.

4. The unlocking method as recited in claim 3, after detecting the contact with the plurality of detection points, further comprising a step of:
displaying an unlocking image on the panel.

5. The unlocking method as recited in claim 4, wherein the contact comprises moving the unlocking image on the sliding path.

6. The unlocking method as recited in claim 1, wherein the step of that the sensing unit receives the biometric data and the step of reading the contact are executed synchronously.

7. The unlocking method as recited in claim 2, wherein when the contact is a click, the contact data comprises contact position and/or contact frequency, and the predetermined contact data comprises predetermined contact position and/or predetermined contact frequency.

8. The unlocking method as recited in claim 1, wherein the biometric data comprises fingerprint, iris, gesture or palmprint.

9. The unlocking method as recited in claim 1, wherein the sensing unit comprises a fingerprint recognition unit, an iris recognition unit, a gesture recognition unit or a palmprint recognition unit.

10. The unlocking method as recited in claim 1, wherein the predetermined biometric data comprises a fingerprint pattern, an iris pattern, a gesture pattern or a palmprint pattern.

11. The unlocking method as recited in claim 1, wherein the user operates the hand-held electronic device by one hand.

12. A shadeless touch hand-held electronic device, comprising:
a panel;
a touch-sensing cover comprising a cover and a touch-sensing structure, wherein partial or total area of the touch-sensing structure is disposed on the cover and the touch-sensing structure comprises a plurality of detection points;
a sensing unit; and
a control unit electrically connected with the panel, the touch-sensing cover and the sensing unit and executing steps comprising:
detecting a trigger event from a plurality of detection points of the touch-sensing cover when the hand-held electronic device is in a locked state of user interface;
receiving a biometric data sensed by the sensing unit;
comparing the biometric data with a predetermined biometric data stored in the hand-held electronic device;
reading a contact between the user and the plurality of detection points of the touch-sensing cover to form a contact data;
comparing the contact data with a predetermined contact data stored in the hand-held electronic device; and
switching the hand-held electronic device into an unlocked state of user interface.

13. The hand-held electronic device as recited in claim 12, which is applied to single-hand multi-point touch.

14. The hand-held electronic device as recited in claim 12, wherein a circuit board, a battery or a memory card is disposed between the touch-sensing cover and the panel.

15. The hand-held electronic device as recited in claim 12, wherein the sensing unit comprises a fingerprint recognition unit, an iris recognition unit, a gesture pattern or a palmprint recognition unit.

16. The hand-held electronic device as recited in claim 12, wherein the sensing unit is coupled with the touch-sensing cover.

17. The hand-held electronic device as recited in claim 12, wherein a wiring connecting to the touch-sensing structure is gathered to a single side for wiring outlet.

18. The hand-held electronic device as recited in claim 12, wherein the area of the touch-sensing structure and the area of the panel have a ratio relationship, and the control unit converts an input position into a display position of the panel according to the ratio relationship.

19. The hand-held electronic device as recited in claim 12, wherein the touch-sensing structure comprises metal mesh, metal nanowires, transparent conducting layer, carbon nanotube or graphene.

20. The hand-held electronic device as recited in claim 12, wherein the touch-sensing cover further comprises a near field communication unit, which comprises a near field communication chip and an antenna, the near field communication chip is electrically connected with the control unit, and the antenna is disposed on the cover or the touch-sensing structure.
